(19) United States
(12) Patent Application Publication
(10) Pub. No.: US 2026/0118619 A1
(43) Pub. Date: Apr. 30, 2026

(54) MANUFACTURING METHOD FOR OPTICAL FIBER RIBBON AND OPTICAL FIBER RIBBON

(71) Applicant: SUMITOMO ELECTRIC INDUSTRIES, LTD., Osaka (JP)

(72) Inventors: Kentaro TAKEDA, Osaka (JP); Ryoei OKA, Osaka (JP); Reo AMANO, Osaka (JP)

(21) Appl. No.: 19/374,103

(22) Filed: Oct. 30, 2025

(30) Foreign Application Priority Data
Oct. 31, 2024 (JP) 2024-191662

(51) Int. Cl. G02B 6/44

(52) U.S. Cl. CPC G02B 6/4482; G02B 6/448

(57) ABSTRACT

A manufacturing method for an optical fiber ribbon having markings applied to a surface thereof. The method includes: forming an optical fiber ribbon including a plurality of optical fibers disposed in parallel and a connecting member formed of an ultraviolet curable resin connecting the plurality of optical fibers; applying an ultraviolet curable resin for markings to the surface of the optical fiber ribbon; and forming markings by irradiating the ultraviolet curable resin for the markings with ultraviolet light.

### TECHNICAL FIELD

The present disclosure relates to a manufacturing method for an optical fiber ribbon and the optical fiber ribbon. This application claims priority based on Japanese Patent Application No. 2024-191662 filed on October 31, 2024, and the entire contents of which are incorporated herein by reference.

### BACKGROUND

JP2007-178883A discloses a manufacturing method for an optical fiber ribbon which applies markings for identifying subunits on the surface of the optical fiber ribbon.

JPH02-033230U discloses an optical fiber coating device with markings for adjusting thickness deviations applied on a side surface of a resin that coats the periphery of an optical fiber.

### SUMMARY

The present disclosure aims to provide a manufacturing method for an optical fiber ribbon with which the markings formed on the surface are less likely to peel off, and the optical fiber ribbon.

A manufacturing method for an optical fiber ribbon according to the present disclosure is a method for manufacturing an optical fiber ribbon having markings applied to a surface thereof, in which the method includes: forming an optical fiber ribbon including a plurality of optical fibers disposed in parallel and a connecting member formed of an ultraviolet curable resin connecting the plurality of optical fibers; applying an ultraviolet curable resin for markings onto the surface of the optical fiber ribbon; and forming markings by irradiating the ultraviolet curable resin for the markings with ultraviolet light.

### BRIEF DESCRIPTION OF THE DRAWINGS

FIG. 1 is a plan view illustrating a configuration of an optical fiber ribbon according to the present embodiment.

FIG. 2 is a cross-sectional view illustrating the configuration in cross section taken along line II-II in FIG. 1 viewed from the direction of the arrows.

FIG. 3 is a conceptual diagram illustrating a configuration of a manufacturing apparatus for an optical fiber ribbon.

FIG. 4 is a conceptual diagram illustrating another configuration of a manufacturing apparatus for an optical fiber ribbon.

### DETALED DESCRIPTION

With the manufacturing method for the optical fiber ribbon described in JP2007-178883A, when the optical fiber ribbon is brought into contact with another object before the ink for markings printed on the surface of the optical fiber ribbon dries, the ink will adhere to the contacting object. To prevent such ink adhesion, it is necessary to provide a drying pass line in the optical fiber ribbon manufacturing equipment or limit the manufacturing speed of the optical fiber ribbon.

In the optical fiber coating device described in JPH02-033230U, the markings are used to adjust the thickness deviation of the resin coated around the optical fiber, rather than to identify the optical fiber.

According to the present disclosure, it is possible to provide a manufacturing method for an optical fiber ribbon with which the markings formed on the surface are less likely to peel off, and the optical fiber ribbon.

### Description of Embodiment of Present Disclosure

First, embodiments of the present disclosure will be listed and described.

1 A manufacturing method for an optical fiber ribbon according to the present disclosure is a method for manufacturing an optical fiber ribbon having markings applied to a surface thereof, in which the method includes: forming an optical fiber ribbon including a plurality of optical fibers disposed in parallel and a connecting member formed of an ultraviolet curable resin connecting the plurality of optical fibers; applying an ultraviolet curable resin for markings onto the surface of the optical fiber ribbon; and forming markings by irradiating the ultraviolet curable resin for the markings with ultraviolet light.

According to the method described above, since the resin of the markings and the resin of the connecting member are both ultraviolet curable resins, the adhesion of the resins to each other is high, and the markings are less likely to peel off even when the optical fiber ribbon comes into contact with other objects. Furthermore, since the resin of the markings is cured by ultraviolet irradiation, there is no need to provide a pass line for drying, which prevents an increase in size of the optical fiber ribbon manufacturing equipment.

2 In the above (1), the forming the optical fiber ribbon may include: applying the ultraviolet curable resin for the connecting member to connect the plurality of optical fibers disposed in parallel; and irradiating the ultraviolet curable resin for the connecting member with the ultraviolet light to form the connecting member.

In some cases, when the resin of the markings is applied onto uncured resin of the connecting member, the resin of the connecting member may deform, resulting in deformation of the cured connecting member. According to the method described above, the resin of the connecting member is approximately half-cured or fully cured before the resin of the markings is applied, making the connecting member less likely to deform.

3 The optical fiber ribbon according to the present disclosure is an optical fiber ribbon having markings applied to a surface thereof, which includes the optical fiber ribbon including a plurality of optical fibers disposed in parallel and a connecting member formed of an ultraviolet curable resin connecting the plurality of optical fibers, and the markings formed of the ultraviolet curable resin on the surface of the optical fiber ribbon.

According to the configuration described above, since the resin of the markings and the resin of the connecting member are both ultraviolet curable resins, the adhesion of the resins to each other is high, and the markings are less likely to peel off even when the optical fiber ribbon comes into contact with other objects.

### Details of Embodiments of Present Disclosure

Specific examples of the manufacturing method for optical fiber ribbon and the optical fiber ribbon of the present disclosure are described below with reference to the drawings. In addition, the present disclosure is not limited to these examples only, but is intended to be indicated by the claims, and include all modifications within the scope and meaning equivalent to the claims.

### Optical Fiber Ribbon

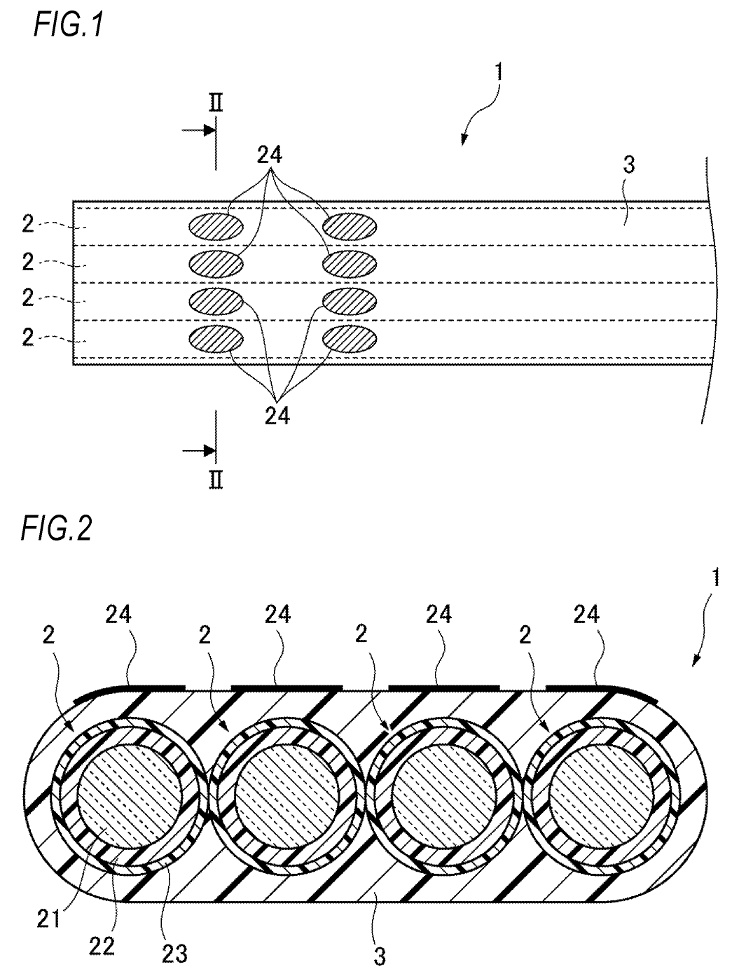

FIG. 1 is a plan view illustrating a configuration of an optical fiber ribbon 1 according to the present embodiment. FIG. 2 is a cross-sectional view illustrating the configuration in cross section taken along the line II-II in FIG. 1 viewed from the direction of the arrows.

As illustrated in FIGS. 1 and 2, the optical fiber ribbon 1 includes a plurality of optical fibers 2. The plurality of optical fibers 2 are disposed in parallel. In the present example, four optical fibers 2 are disposed in parallel, with adjacent optical fibers 2 in contact with each other. In addition, the number of optical fibers 2 is not limited to four. Alternatively, the plurality of optical fibers 2 may be disposed in parallel, with adjacent optical fibers 2 spaced apart from each other.

As illustrated in FIG. 2, each of the plurality of optical fibers 2 includes a glass fiber 21, a coating layer 22, and a colored layer 23. The glass fiber 21 includes a core and a cladding. The coating layer 22 is formed around the glass fiber 21. For example, the coating layer 22 is formed of an ultraviolet curable resin. The optical fibers 2 may include a plurality of coating layers 22.

The colored layer 23 is formed around the coating layer 22. The colored layer 23 serves as an indicator to identify the individual optical fibers 2. For example, the colored layer 23 is colored in different colors for each of the optical fibers 2. For example, the colored layer 23 is formed of an ultraviolet curable resin mixed with a pigment.

The optical fiber ribbon 1 includes a connecting member 3. The connecting member 3 is formed of an ultraviolet curable resin. The connecting member 3 connects the plurality of optical fibers 2. In the present example, the connecting member 3 covers the entire periphery of the plurality of optical fibers 2, and adjacent optical fibers 2 are connected along a longitudinal direction.

Markings 24 are applied to a surface of the optical fiber ribbon 1. In the present example, the markings 24 are formed on the connecting member 3 that forms an outer surface of the optical fiber ribbon 1. The markings 24 serve as indicators to identify the optical fiber ribbon 1 to which the optical fibers 2 belong.

The markings 24 are formed of an ultraviolet curable resin. For example, the ultraviolet curable resin is colored by mixing a pigment.

As illustrated in FIG. 1, in the present example, for each optical fiber 2, two elliptical markings 24 are formed at predetermined intervals in the longitudinal direction. In the present example, the shape and color of the markings 24, as well as the position of the markings 24 of the optical fibers 2 in the longitudinal direction, are the same for all optical fibers 2 included in the optical fiber ribbon 1. In addition, the position, shape, and number of the markings 24 are not limited to the above example.

### Manufacturing Method for Optical Fiber Ribbon

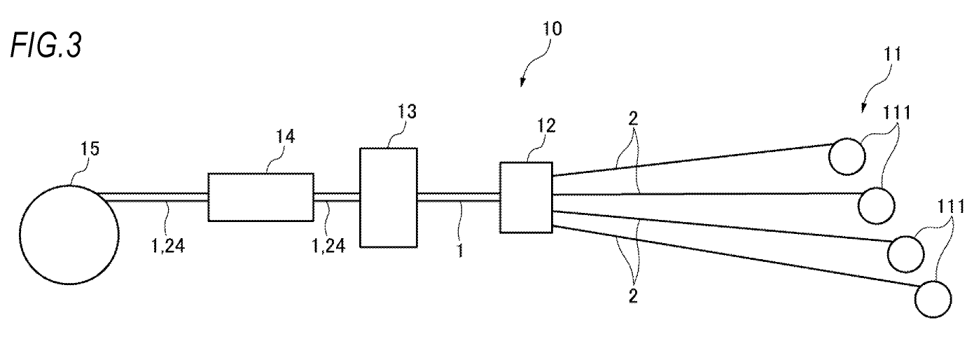

Next, a method for manufacturing the optical fiber ribbon 1 will be described with reference to FIG. 3. FIG. 3 is a schematic diagram illustrating a manufacturing apparatus 10 for the optical fiber ribbon 1 according to the present embodiment.

The manufacturing apparatus 10 includes a supply unit 11, a first resin application device 12, a second resin application device 13, a resin curing device 14, and a winding unit 15.

The supply unit 11 includes, for example, a plurality of supply bobbins 111 that supply the plurality of optical fibers 2 included in the optical fiber ribbon 1. Each supply bobbin 111 is wound with the optical fibers 2 previously formed by a drawing device (not shown).

The first resin application device 12 is configured to apply the ultraviolet curable resin for the connecting member 3 around the optical fibers 2 disposed in parallel. The second resin application device 13 is configured to apply the ultraviolet curable resin for the markings 24 onto the connecting member 3. For example, the second resin application device 13 applies the ultraviolet curable resin for the markings 24 to positions on the connecting member 3 corresponding to each optical fiber 2.

The resin curing device 14 is configured to cure the ultraviolet curable resin for the connecting member 3 and the ultraviolet curable resin for the markings 24 by irradiating them with ultraviolet light. The winding unit 15 is configured to wind up the optical fiber ribbon 1 having the markings 24 applied thereto.

With the manufacturing method for the optical fiber ribbon 1, first, the optical fibers 2 are fed from each supply bobbin 111, and the fed optical fibers 2 are conveyed to the first resin application device 12. In the first resin application device 12, the ultraviolet curable resin for the connecting member 3 is applied around the plurality of optical fibers 2 while the plurality of optical fibers 2 are disposed in parallel.

The plurality of optical fibers 2 applied with the ultraviolet curable resin for the connecting member 3 are conveyed to the second resin application device 13. In the second resin application device 13, the ultraviolet curable resin for the markings 24 is applied onto the ultraviolet curable resin for the connecting member 3 applied around the plurality of optical fibers 2.

The plurality of optical fibers 2 applied with the ultraviolet curable resin for the markings 24 are conveyed to the resin curing device 14. In the resin curing device 14, the ultraviolet curable resin for the connecting member 3 and the ultraviolet curable resin for the markings 24 are cured by irradiation with ultraviolet light. As a result, the optical fiber ribbon 1 having the markings 24 applied to the surface thereof is formed. The optical fiber ribbon 1 having the markings 24 applied thereto is wound around the winding unit 15.

With the manufacturing method for the optical fiber ribbon 1 and the optical fiber ribbon 1 of the present embodiment, since the resin of the markings 24 and the resin of the connecting member 3 are both ultraviolet curable resins, the adhesion of the resins to each other is high, and the markings 24 are less likely to peel off even when the optical fiber ribbon 1 comes into contact with other objects. Furthermore, since the resin of the markings 24 is cured by ultraviolet irradiation, there is no need to provide a pass line for drying, which prevents an increase in size of the optical fiber ribbon 1 manufacturing equipment.

In addition, with the manufacturing method for the optical fiber ribbon 1 described above, the resin of the connecting member 3 and the resin of the markings 24 are cured at the same time. However, the resin of the connecting member 3 may be fully cured or approximately half-cured before the resin of the markings 24 is applied.

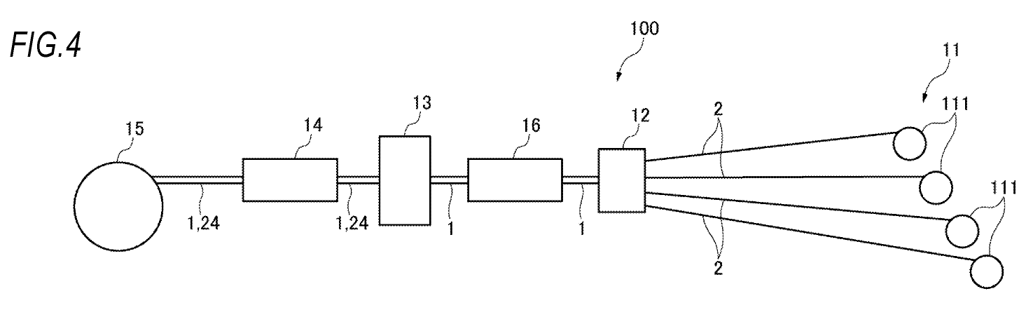

FIG. 4 is a schematic diagram illustrating a manufacturing apparatus 100 for the optical fiber ribbon 1 according to a modification. The manufacturing apparatus 100 in FIG. 4 differs from the manufacturing apparatus 10 in FIG. 3 in that a resin curing device 16 is disposed between the first resin application device 12 and the second resin application device 13.

The plurality of optical fibers 2, fed from the supply unit 11 and applied with the ultraviolet curable resin for the connecting member 3 by the first resin application device 12, are conveyed to the resin curing device 16. In the resin curing device 16, the ultraviolet curable resin for the connecting member 3 is cured by irradiation with the ultraviolet light. The ultraviolet curable resin for the connecting member 3 may be fully cured or approximately half-cured.

The plurality of optical fibers 2, in which the ultraviolet curable resin for the connecting member 3 is cured, are conveyed to the second resin application device 13. In the second resin application device 13, the ultraviolet curable resin for the markings 24 is applied onto the ultraviolet curable resin for the connecting member 3 formed around the plurality of optical fibers 2.

The plurality of optical fibers 2 applied with the ultraviolet curable resin for the markings 24 are conveyed to the resin curing device 14. In the resin curing device 14, the ultraviolet curable resin for the markings 24 is cured by irradiation with the ultraviolet light. When the ultraviolet curable resin for the connecting member 3 is not fully cured, the ultraviolet curable resin for the connecting member 3 is also cured in the resin curing device 14. As a result, the optical fiber ribbon 1 having the markings 24 applied to the surface thereof is formed.

As described above, the resin for the connecting member 3 is approximately half-cured or fully cured before the resin of the markings 24 is applied, making the connecting member 3 less likely to deform when the resin of the markings 24 is applied.

Here, the "process of applying the ultraviolet curable resin for the markings to the surface of the optical fiber ribbon" in the present disclosure may include not only the process of applying the ultraviolet curable resin for markings to the surface of the optical fiber ribbon in a state where the resin for the connecting member is fully cured, but also the process of applying the ultraviolet curable resin for markings to the surface of the optical fiber ribbon in a state where the resin for the connecting member is completely uncured or approximately half-cured.

As described above, while the present disclosure has been described in detail and with reference to specific embodiments thereof, it will be apparent to those skilled in the art that various changes and modifications can be made without departing from the spirit and scope of the invention. Further, the numbers, positions, shapes, and the like of the elements described above are not limited to those of the above embodiments, but can be changed to any other numbers, positions, shapes and the like to carry out the present disclosure.

In the embodiments described above, the adjacent optical fibers 2 are connected along the longitudinal direction of the optical fibers 2 by the connecting member 3. However, by forming notches at predetermined intervals in a part of the connecting member 3 positioned between the adjacent optical fibers 2, the adjacent optical fibers 2 may be formed to be connected intermittently in the longitudinal direction. For example, in the manufacturing apparatus 10 of FIG. 3, a device for forming the notches is disposed between the resin curing device 14 and the winding unit 15.

In the embodiment described above, the connecting member 3 covers the entire periphery of the plurality of optical fibers 2. However, the connecting member 3 may also be formed to cover a part of the periphery of the plurality of optical fibers 2, such as being formed only in a connecting portion between the plurality of adjacent optical fibers 2. In this case, an outermost layer of the optical fibers 2 (in the present example, the colored layer 23) in addition to the connecting member 3 forms the outer surface of the optical fiber ribbon 1, and the markings 24 are formed on the outermost layer of the optical fibers 2 and the connecting member 3. By forming the outermost layer of the optical fibers 2 and the connecting member 3 with the ultraviolet curable resin, the adhesion between the outermost layer of the optical fibers 2 and the connecting member 3 and the markings 24 is improved, making the markings 24 less likely to peel off.

In the embodiment described above, the markings 24 serve as an indicator to identify the optical fiber ribbon 1 to which the optical fibers 2 belong. However, for example, when the optical fiber ribbon 1 includes a plurality of subunits, each including a plurality of optical fibers 2 connected by the connecting member 3, and a subunit connecting member formed of an ultraviolet curable resin connecting the plurality of subunits disposed in parallel, the markings 24 may serve as an indicator to identify the subunits. When the subunit connecting member covers the entire periphery of the plurality of subunits, the markings 24 are formed on the subunit connecting member that forms the outer surface of the optical fiber ribbon 1. That is, the subunit connecting member corresponds to the "connecting member formed of ultraviolet curable resin connecting the plurality of optical fibers" of the present disclosure. When the subunit connecting member covers only a part of the periphery of the plurality of subunits, the markings 24 are formed on the subunit connecting member that forms the outer surface of the optical fiber ribbon 1 and the connecting member 3.

What is claimed is:

1. A manufacturing method for an optical fiber ribbon having markings applied to a surface thereof, the method comprising:
forming an optical fiber ribbon including a plurality of optical fibers disposed in parallel and a connecting member formed of an ultraviolet curable resin connecting the plurality of optical fibers;
applying an ultraviolet curable resin for markings to the surface of the optical fiber ribbon; and
forming markings by irradiating the ultraviolet curable resin for the markings with ultraviolet light.

2. The manufacturing method according to claim 1, wherein the forming the optical fiber ribbon includes:
applying the ultraviolet curable resin for the connecting member to connect the plurality of optical fibers disposed in parallel; and
irradiating the ultraviolet curable resin for the connecting member with ultraviolet light to form the connecting member.

3. An optical fiber ribbon having markings applied to a surface thereof, comprising:
an optical fiber ribbon including a plurality of optical fibers disposed in parallel and a connecting member formed of an ultraviolet curable resin connecting the plurality of optical fibers; and
markings formed of an ultraviolet curable resin formed on a surface of the optical fiber ribbon.
